(19) United States
(12) Patent Application Publication
(10) Pub. No.: US 2002/0184332 A1
(43) Pub. Date: Dec. 5, 2002

(54) Physical registration method and system for resources

(76) Inventors: Timothy Paul James Kindberg, Burlingame, CA (US); John Joseph Barton, Los Gatos, CA (US)

Correspondence Address: HEWLETT-PACKARD COMPANY, Intellectual Property Administration, P.O. Box 272400, Fort Collins, CO, 80527-2400, US

(21) Appl. No.: 09/871,082

(22) Filed: May 30, 2001

(51) Int. Cl. G06F 15/16

(52) U.S. Cl. 709/217; 709/245

(57) ABSTRACT

A physical registration method and system for registering resources associated with corresponding entities so that users and programs may browse and automatically discover the resources. There are one or more resources that need to be registered. A portable computing device for executing a physical registration program can be used to perform the resource registration. The portable computing device can be used to physically interact with the entity (e.g., approach the entity to read a tag, to send a registry address, or to receive a transmitted resource address) in order to register the resource associated with the entity. Once the resource address is obtained, the resource address is bound to a registry for a collection that may be defined by a user.

### FIELD OF THE INVENTION

The present invention relates generally to web-based computing systems, and more particularly, to a physical registration method and system for resources (e.g., computing resources).

### BACKGROUND OF THE INVENTION

Hewlett-Packard Laboratories, the assignee of the present patent application, has an on-going research project entitled, “CoolTown.” The CoolTown project explores the combination of web technology, portable devices and wireless communication to develop new kinds of systems that have been described as nomadic and ubiquitous.

The CoolTown project emphasizes links between web resources and physical objects and places. Users can then interact with the resources by using information appliances (e.g., laptop computers and personal digital assistants (PDAs)). For further information regarding the CoolTown project, the reader is directed to the CoolTown homepage http://www.cooltown.hp.com.

An important enabling technology to web-based computing systems, such as the CoolTown project, is how to register computational resources associated with a physical setting for browsing and automatic discovery by users and programs.

One approach to registering resources is the use of zone or cell-based techniques. Zone-based tracking methods can be used to identify the location of devices and other objects and associate these objects with a location. Examples of zone-based tracking methods include postal codes and ‘911’ cellular telephone tracking. However, these techniques are too coarse for fine-grained places (i.e., these techniques do not provide sufficient resolution for places that are close together). Examples of fine-grained places are adjacent stores in a mall, adjacent meeting rooms on the same floor, and exhibition stands in a convention hall.

In other words, zone-based techniques cannot distinguish between two objects in the same zone even though the objects are located in different locations in that zone. A zone is simply the smallest distinguishable area. For example, if the resolution or the smallest distinguishable area is an area that is a 500 feet by 500 feet square, any resources located at different locations in this square are considered by the technique to have the same location (i.e., the same zone).

A second approach to resource registration involves the use of triangulation-based tracking systems. Examples of triangulation-based tracking systems include satellite-based systems (e.g., GPS), radio frequency (RF) based systems, and acoustic schemes. Although triangulation-based tracking systems are more accurate than the zone-based systems, this approach is inadequate for registering resources in places that have a fuzzy or complex topology. Furthermore, these approaches tend to provide inadequate resolution for fine-grained localities. Moreover, radio-based systems including GPS provide poor performance for indoor applications when signals are unable to penetrate walls.

Neither zone-based nor triangulation systems organize resources according to likely-usage patterns. For example, a conference room used frequently by visitors may be physically near a printer that is inappropriate for casual use. Consequently, it is desirable for there to be a registration mechanism that allows a user to register resources that takes into account usage patterns.

A third approach to registering resources involves network discovery systems. An example of a network discovery system is described in a publication entitled, “Service Location Protocol: Automatic Discovery of IP Network Services,” by Eric Guttman, IEEE Internet Computing, Vol. 3, No. 4, pp. 71-80, July/August 1999.

Unfortunately, these network discovery systems do not provide or support the notion of a physical setting or vicinity about a physical point. For example, the ability to reach a particular network resource within a predetermined number of hops is often used to define what is local to a particular place.

Consider the example of neighboring meeting rooms or exhibition stands. These rooms or stands may utilize the same wireless network that can permeate, for example, the entire floor. Consequently, there is nothing in the network discovery system that corresponds to or that can be utilized to specify the specific location of the rooms and stands.

Based on the foregoing, there remains a need for a computing resource registration method and system that overcomes the disadvantages set forth previously.

### SUMMARY OF THE INVENTION

According to one embodiment of the present invention, a tag-based resource registration method is described. One physically approaches an entity that has an associated tag for registration. The tag is read by a sensor to obtain an identifier for an associated electronically readable resource. By using the identifier, an address for the resource is obtained. The address of the resource is then bound in a registry for a collection of related resources that may be defined by a user. The registry is a computational abstraction that can be browsed by users in the form of web pages. The registry can also be queried automatically by other programs. Users or programs obtain the resource associated with the entity by, for example, web browsing. The resource provides information on the entity or allows the entity to be controlled.

Preferably, a resolver service is employed to obtain an address for the resource. The resolver service receives the resource identifier and in response provides an address for the resource. The resolver includes a table of addresses and the corresponding identifiers for the web pages.

According to another embodiment of the present invention, a beacon-based registration method is provided. In this embodiment, the user physically approaches an entity (e.g., a printer) that may or may not be connected to a network. The user obtains an address for a resource associated with the entity directly from a localized wireless transmission, for example, by infrared. The user is equipped with a handheld device capable of communicating over a network to the registry. The address obtained by the localized transmission to the device is sent by the user to the registry.

According to another embodiment of the present invention, a non tag-based registration method is provided. First, a user physically approaches an entity (e.g., a target device) that is connected to a network. The user sends the address of a registry to a target device by employing, for example, a personal digital assistant. The target device receives the address of the registry and in response accesses the registry through the network by employing the address of the registry. The target device further binds its own address into the registry for a collection that may be defined by a user.

According to another embodiment of the present invention, a physical registration system is provided. The registration system has a target resource that needs to be registered. The system also has a portable computing device for executing a physical registration program that performs the resource registration. Preferably, the portable computing device is used to physically interact with the target device. For example, a user can approach the target resource and employ a hand-held device to register the resource. A registry is provided for associating the addresses of the resources to a collection that may be defined by a user.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates physical registration of resources associated with a place in accordance to one embodiment of the present invention can be utilized.

FIG. 2 is a block diagram that illustrates physical registration that employs a tag in accordance with one embodiment of the present invention.

FIG. 3 is a flowchart of the processing steps performed by the physical registration of FIG. 2 in accordance with one embodiment of the present invention.

FIG. 4 is a block diagram that illustrates physical registration that involves writing the registry address to a target resource in accordance with one embodiment of the present invention.

FIG. 5 is a flowchart of the processing steps performed by the physical registration of FIG. 4 in accordance with one embodiment of the present invention.

FIG. 6 is an exemplary registry in accordance with one embodiment of the present invention.

### DETAILED DESCRIPTION OF THE INVENTION

A physical registration method and system for registering resources (e.g., computational resources) with a collection are described. Once registered the resources may be browsed and automatically discovered by users and programs. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Therefore, the present invention provides a human user with the means to combine electronic sensing technology and wireless network access to configure an on-line electronic directory according to any plan devised by this user at the time of use. The user, having chosen to add an entity to a directory, physically approaches the entity and designates the entity physically by sensing a tag or beacon attached thereon. The sensing activity depends upon the nature of the tag or beacon, but it is carried out by the user moving a hand-held device to within sensing range of the tag or beacon and by the user moving or manipulating the device so as to select the chosen entity. The human interaction is completed when this designation is signaled to the directory by the user. Software or hardware controls on the hand-held device indicate that an address for an online resource corresponding to the entity should be entered into the directory.

Physical Registration of Computing Resources

The present invention provides a convenient manner to identify entities to include in a collection of related entities. The collection may be defined by the user. Specifically, the address of resources that are associated with the entities is bound in a registry of the collection.

In one example, entities that are related to each other by physical proximity to each other or to a particular location (e.g., entities in or near a physical setting) are included in a registry. The physical setting can be, for example, a building, a meeting room, or an exhibition stand.

According to the registration technique of the present invention, a user physically interacts with a target entity in order to register in a registry a resource that is associated with the target entity (hereinafter referred to as a “physical registration”). For example, a user can simply walk up to a target entity and designate the resource underlying the entity for registration. This designation process is described in greater detail hereinafter.

Physical Registration Environment

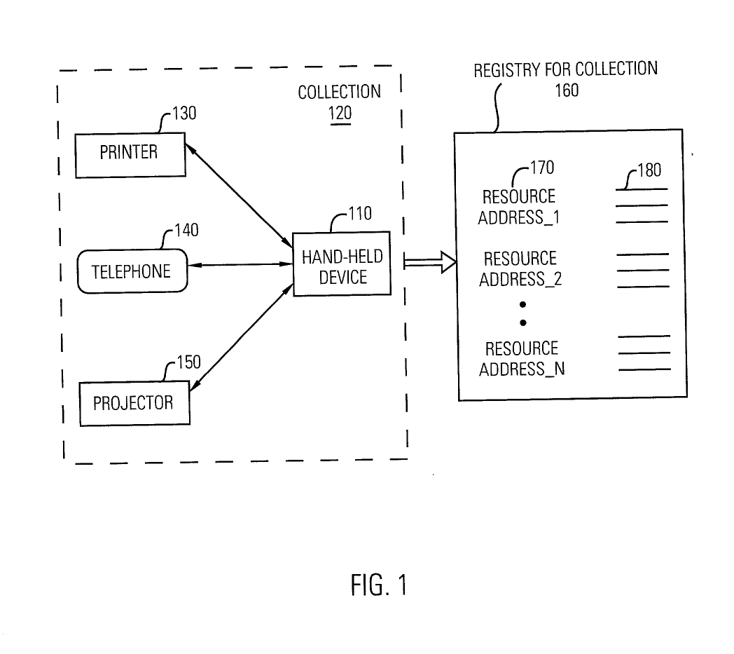

FIG. 1 illustrates physical registration of resources in accordance with one embodiment of the present invention. A collection 120 of entities includes one or more entities that may be registered and grouped together by a user (hereinafter also referred to as target entities). In this example, the collection 120 of entities can be physically related (e.g., entities associated with a particular place). It is noted that the entities can be in the place (e.g., in the meeting room) or can be in the vicinity of the place. However, it is noted that the physical registration method and system of the present invention does note require entities to be physically related or to be related by network connectivity.

The present invention provides techniques to construct a registry for a collection of related entities. It is noted that the entities in a collection can be physically related or related in some other manner that makes sense for the user. For example, the present invention can be utilized to construct registries of geographically dispersed entities (e.g., a registry of interesting objects of art encountered in museums and galleries around the world).

The term entity as used herein is a physical thing, such as a printer, projector, or a painting. The term entity can broadly encompass computational devices, objects, things, electronic components, electronic devices, connected devices (devices that are connected to a computer network or a communication network), communication devices, computers, computer peripherals, books, publications, paintings, maps, facilities in a building, or any thing or item that can be associated with a place and that may be of interest to those who may be in the vicinity of the place or who intend to visit or otherwise use the place.

The term resource is an electronic thing, such as an electronic document or a web server that describes or controls the entity. The term address (e.g., an URL) refers to an electronic address of the resource. Placing the address in the registry allows one to access the resource. The registration method and system of the present invention provides an efficient manner of placing the address of resources in the registry by using a wireless hand-held device.

The place 120 can be any physical setting or location. As described earlier, examples of a place 120 include a building, a meeting room, or an exhibition stand. In this example, the place 120 is a meeting room.

A portable device 110 that can be brought near to the target entities is provided. The portable device 110 can be, for example, a hand-held personal digital assistant (PDA) 110. U.S. Pat. No. 5,956,487, entitled “Embedding Web Access Mechanism in an Appliance for User Interface Functions Including a Web Server and Web Browser,” which is hereby incorporated by reference, further describes appliances that may be registered by utilizing the registration method and system of the present invention.

The physical registration of the present invention involves the physical interaction between a user and a target entity. In this example, a user approaches or walks up to some target entities in the place 120 and physically interacts with the target entities to register one or more of the resources associated with the target entities. One advantage of physical registration is that the registry accurately reflects the user's viewpoint, thereby allowing users to organize the resources representing entities in a manner most appropriate for other users.

In this example, the target entities include a printer 130, a telephone 140, and a slide projector 150. The user can employ the PDA 110 to designate the resources, associated with the printer 130, the telephone 140, and the slide projector 150, for inclusion in a registry 160. The registry 160 describes the addresses for resources available for a place 120 or location (e.g., a meeting room). The registry 160 can include a plurality of resource addresses 170 (e.g., resource_address1, resource_address2, . . . resource_addressN) that each has one or more attributes 180.

In this manner, a particular physical setting can have an associated directory or registry for specifying the resources available at that particular physical setting through the physical registration method and system of the present invention. The web page is generated based on the contents of a resource registry. By designating resources for inclusion according to the teachings of the present invention, a user specifies which resources are discoverable from a particular registry associated with a physical setting.

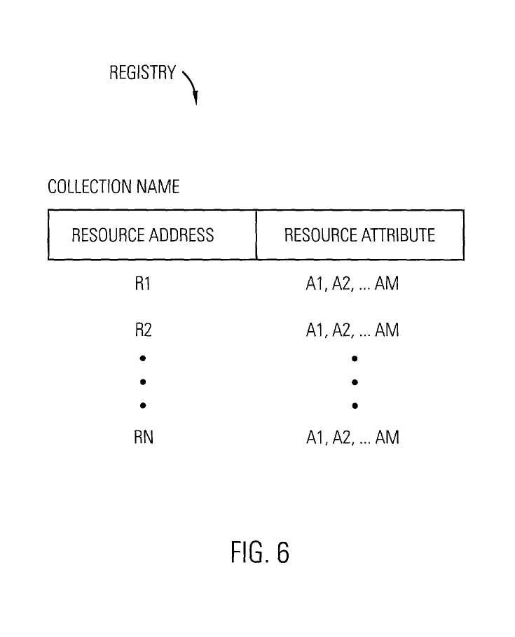

As used herein, the resource registry is a computational abstraction that may be browsed by users in the form of web pages or queried automatically by programs. For each resource, the registry stores the address of the resource and optionally other attributes of the resource. An exemplary registry is described in greater detail hereinafter with reference to FIG. 6.

The registration techniques of the present invention are described herein with an example where all resources are web resources. In this embodiment, the addresses for the resources are Uniform Resource Locators (URLs). However, it is noted that the registration techniques of the present invention can be applied to resources that can be any networked electronic objects that are locatable by any addressing scheme.

Two exemplary processes by which the present invention can accomplish physical registration are now described. These two physical registration processes accomplish a common result. The common result is that the address (e.g., the URL) of the target resource becomes bound in a registry corresponding to a place or location. These processes include 1) a Tag-based Registration and 2) a Registry Address based Registration.

Registration by Reading a Tag

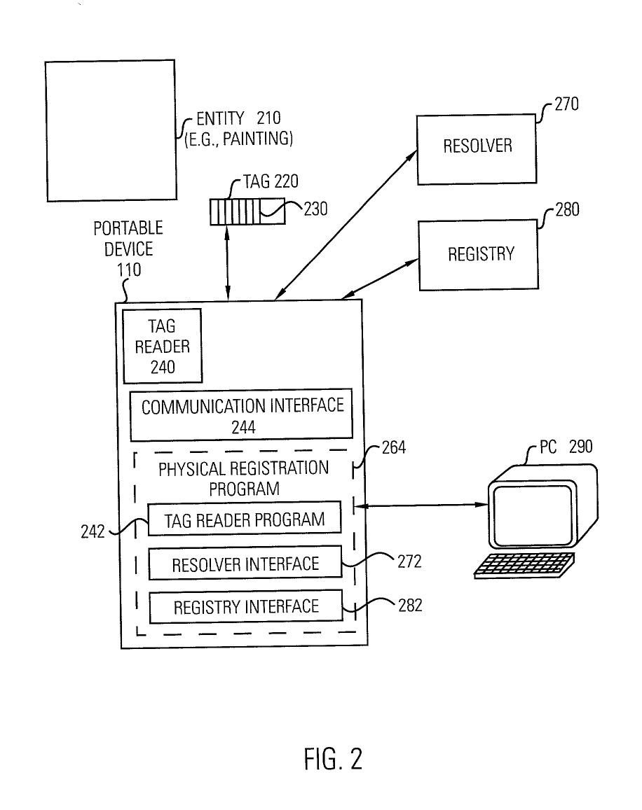

FIG. 2 is a block diagram that illustrates physical registration that employs a tag in accordance with one embodiment of the present invention. This registration process is applicable for any entity 210 that has an identifying tag 220 attached thereto or in the object's vicinity. The entity 210 can be, for example, a painting, a device, or other physical entity. This registration process is especially suitable for non-electronic objects and items.

The identifying tag 220 can be, but is not limited to, a barcode or a radio frequency identifier (RFID) The tag 220 includes an entity identifier 230 (e.g., an alpha numeric string identifier).

In this embodiment, a PDA 110 is equipped with a tag reader 240 that can be, for example, a barcode reader or a RFID reader. The tag reader 240 reads the entity identifier 230 from the tag 220 when the user positions the tag reader 240 near the tag 220.

The PDA 110 also has a communication interface 244 for communicating with other components, such as a resolver 270 and a registry 280 that are described in greater detail hereinafter. The communication interface 244 can be an interface for supporting communication over a serial link, an infrared link, a radio frequency (RF) link, interface for connecting to a computer network, or other communication link.

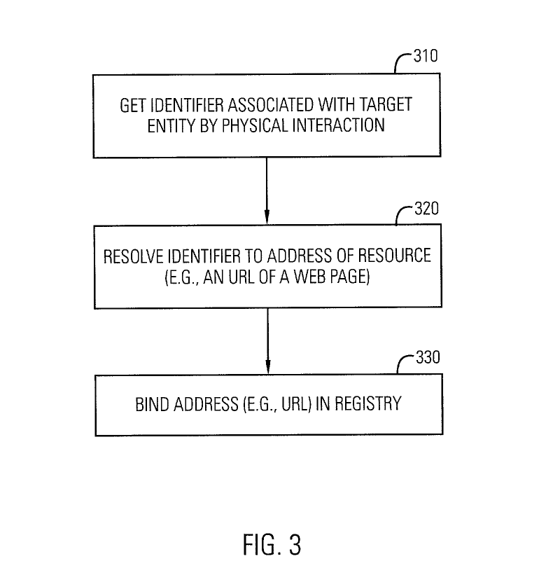

The PDA 110 also includes a physical registration program 264 that when executing on a processor performs the steps set forth in the flowchart of FIG. 3. The physical registration program 264 includes a resolver interface facility 272 for communicating with the resolver 270, a registry interface facility 282 for communicating with the registry 280, and a tag reader program 292 for controlling the tag reader 240.

After obtaining the identifier, the PDA 110 can execute a resolver interface program 272, which manages the communication with the resolver 270 and determines the web page for the object. For example, the resolver interface program 272 can receive the identifier from the tag reader program 292 and provide the identifier to the resolver service 270. The resolver 270 stores a table of addresses and their corresponding identifiers. In response to the identifier, the resolver service 270 provides an address of the resource describing the entity.

Preferably, the resolver interface program 272 employs the resolver service 270 for identifying the address associated with the identifier. However, it is noted that other mechanisms can be utilized to generate an address of the resource. These mechanism can include, but are not limited to, a local database in the hand-held device or a remote general purpose database on the Internet.

The registry interface program 282 communicates with the registry 280 to bind the address of the target resource into the registry 280. Preferably, the address is the URL for the web page of the target resource.

Alternatively, the PDA 110 can be used only for storing the scanned identifiers of the resources. In this embodiment, the registration of the resources can be accomplished subsequently, perhaps through the use of a personal computer (PC) 290. In this embodiment, the PC 290 has the physical registration program 264 for performing the resolving function and binding function.

FIG. 3 is a flowchart of the processing steps performed by the physical registration of FIG. 2 in accordance with one embodiment of the present invention. In step 310, the identifier associated with a target entity is obtained by physical interaction. In step 320, a resolver 270 is utilized to resolve the identifier to an address of the resource (e.g., a URL of a web page). In step 330, the address of the resource (e.g., URL) is bound in a registry for a collection of entities. For example, the registry can correspond to entities that are related to a particular place, location, or physical setting.

Registration by Reading a Beacon

In this embodiment, a beacon-based registration technique is utilized. First, a user physically approaches an entity that has an associated beacon. Second, the beacon is read to obtain an address for the resource of the entity. Then, the address of the resource is bound in a registry. In this embodiment, a beacon that is associated with an entity provides the address of a resource that describes or controls the entity.

Further details concerning particular embodiments of a web address beacon may be found in the following copending patent application entitled, “Web Address Beacon for Allowing Fast and Convenient Web Navigation,” by inventors Jeffery A. Morgan, Marcos K. Frid, John C. Schettino, Bill Serra, and Jean Tourrilhes, which was filed on Jul. 17, 2000 and which is hereby incorporated herein by reference.

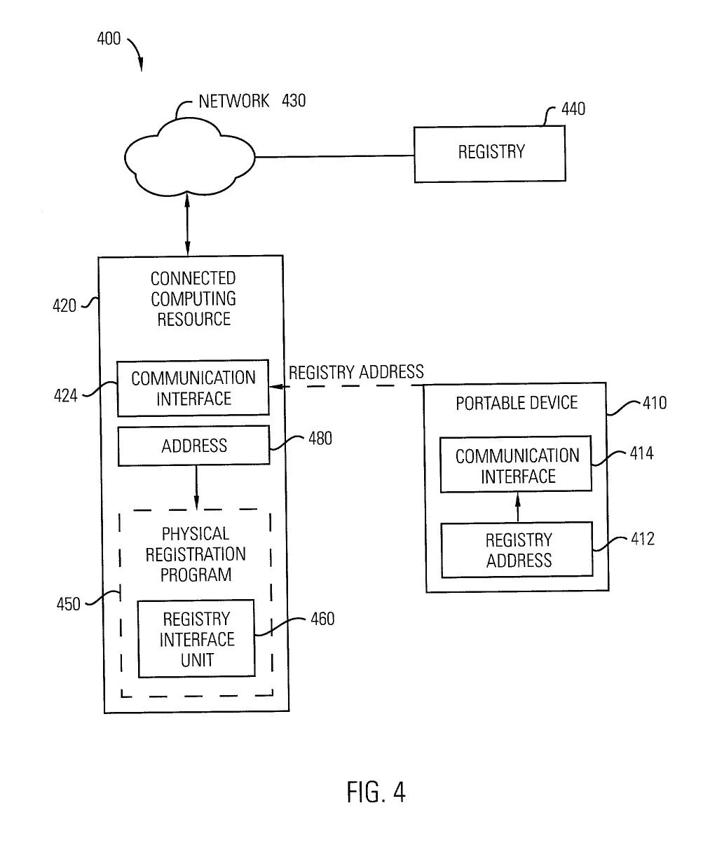

Registration by Writing the Registry Address FIG. 4 is a block diagram that illustrates physical registration that involves writing the registry address to a target resource in accordance with one embodiment of the present invention. The environment 400 includes a portable device 410 (e.g., a PDA) and a connected target resource 420. In this case, the connected target resource 420 is a connected computing device, such as a printer that is coupled to a network 430. The target device 420 has access to a registry 440 through the network 430.

The portable device 410 includes a registry address 412 that corresponds to the registry 440. The portable device 410 also includes a communication interface 414 for sending the registry address 412 to target resources (e.g., connected computing resource 420). The communication interface 414 can include a transmitter (e.g., a RF transmitter, IR transmitter, etc.).

The connected computing resource 420 has a communication interface 424 for receiving the registry address. The communication interface 424 includes a receiver (e.g., a RF receiver, IR receiver, etc.) that corresponds to the type of transmitter in the portable device 410.

A user can carry the portable device 410 that has stored therein the address (e.g., the URL) of the registry 430. The target device 420 is connected to a network and includes a receiver 440 for receiving an address transmitted thereto by the PDA 110. The receiver 440 can be, for example, an IR receiver for receiving an infra red signal transmitted by an IR transmitter disposed in the PDA 110. The communication interface 424 also communicates with the registry 440 through the network 430. The resource 420 also includes a physical registration program 450 that has a registry interface unit 460.

In this embodiment, a user can physically interact with the target resource 420 by moving the portable device 410 in the vicinity of the target device 420 and commanding the portable device 410 to transmit the address (e.g., the URL) 412 of the registry 440 to the target device 420. The target device 420 receives the address 412 of the registry and responsive thereto utilizes the registry interface unit 460 for sending its address 480 to the registry 440. The registry interface unit 460 further registers the URL of its web page with the registry 440.

For example, a web appliance that receives an address to a registry associated with a physical location can supply its own address and bind its own address to the registry. It is noted that this type of registration is applicable only for devices that are electronically configured in a manner to allow for access to the registry.

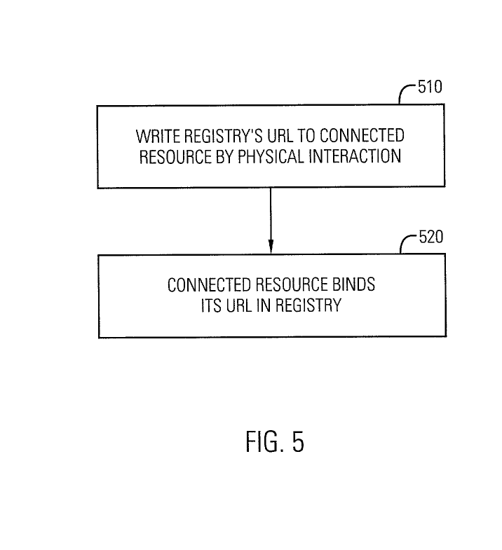

FIG. 5 is a flowchart of the processing steps performed by the physical registration of FIG. 4 in accordance with one embodiment of the present invention. In step 510, an address corresponding to a registry is written to a connected target resource by physical interaction. In step 520, the connected target resource binds its URL in the registry.

FIG. 6 illustrates an exemplary registry for a collection of entities. The registry can include the address of the resource (e.g., a web page) and one or more attributes of the resource. Each resource is associated with a respective entity in the collection. The attributes can, for example, describe the features, specifications, or ability of the resource. Alternatively, the registry can store only the resource address without any attributes. In this case, the attributes can be dynamically extracted from the resource when the attributes are needed by a user.

One advantage of the physical registration techniques provided by the present invention is that the techniques allow a user to accurately identify what entities are to be included in a particular collection. The entities can, for example, be related to a particular physical setting. Another advantage of the physical registration techniques provided by the present invention is that the techniques allow a user to specify both electronic and non-electronic entities. For example, although books or museum exhibits are not computing entities in themselves, the registration techniques of the present invention allows these non-electronic entities to be associated with corresponding web pages that provide information and other services based around them.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A resource registration method comprising the steps of:
a) physically approaching an entity that has an associated tag;
b) reading the tag to obtain an identifier for the resource;
c) using the identifier to obtain an address for the resource; and
d) binding the address of the resource in a registry.

2. The resource registration method of claim 1 wherein the step of using the identifier to obtain an address for the resource includes the step of:
providing a resolver service;
providing the resource identifier to the resolver service;
the resolver service for receiving the resource identifier and responsive thereto for providing an address for the resource; wherein the resolver service includes a table of resource identifiers and the corresponding resource addresses.

3. The resource registration method of claim 1 wherein the registry is a computational abstraction that can be browsed by users in the form of web pages; and wherein the registry can be queried automatically by other programs.

4. The resource registration method of claim 1 wherein the registry stores the address for each resource.

5. The resource registration method of claim 4 wherein the registry stores at least one attribute for each resource.

6. The resource registration method of claim 1 wherein the address for the resource is a URL.

7. The resource registration method of claim 1 wherein the registry describes entities and their associated resources available for use in one of a physical area, a location, and a place.

8. The resource registration method of claim 1 wherein the tag is one of a barcode tag and an RFID tag.

9. The resource registration method of claim 1 further comprising the steps of:
generating a web page for the registry.

10. A resource registration method comprising the steps of:
a) physically approaching a resource that is connected to a network;
b) sending an address of a registry to a target device;
c) the target device having an address for receiving the address of the registry and responsive thereto for accessing the registry through the network by employing the address of the registry, and for binding the address of the target device to a web page of a physical location in the registry.

11. The resource registration method of claim 10 wherein the registry is a computational abstraction that can be browsed by users in the form of web pages; and wherein the registry can be queried automatically by other programs.

12. The resource registration method of claim 10 wherein the registry stores the address for each resource.

13. The resource registration method of claim 12 wherein the registry stores at least one attribute for each resource.

14. The resource registration method of claim 10 wherein the address for the resource is a URL.

15. The resource registration method of claim 10 wherein the registry describes entities and their associated resources available for use in one of a physical area, a location, and a place.

16. A resource registration method comprising the steps of:
a) physically approaching an entity that has an associated beacon;
b) reading the beacon to obtain an address for the resource; and
c) binding the address of the resource in a registry.

17. The resource registration method of claim 16 wherein the registry is a computational abstraction that can be browsed by users in the form of web pages; and wherein the registry can be queried automatically by other programs.

18. The resource registration method of claim 16 wherein the registry stores the address for each resource, and wherein the address for the resource is a URL.

19. The resource registration method of claim 18 wherein the registry stores at least one attribute for each resource.

20. A registration system comprising:
a) a resource that needs to be registered;
b) a portable computing device for executing a physical registration program that performs the resource registration; wherein the portable computing device can be used to physically approach the resource in order to register the resource; and
c) a registry for associating the addresses of the resources to at least one web page of physical locations.
